(19) United States
(12) Patent Application Publication
(10) Pub. No.: US 2022/0105570 A1
(43) Pub. Date: Apr. 7, 2022

(54) Pulse Transfer for Large Area Metal Fusion System

(71) Applicant: 3D Systems, Inc., Rock Hill, SC (US)

(72) Inventors: Bryon Robert Hazlewood, San Diego, CA (US); Jose Julio Doval, Escondido, CA (US); Evan C. Freiburg, San Diego, CA (US)

(21) Appl. No.: 17/487,270

(22) Filed: Sep. 28, 2021

Related U.S. Application Data
(60) Provisional application No. 63/087,105, filed on Oct. 2, 2020.

(51) Int. Cl. B22F 12/57; B33Y 10/00; B33Y 30/00; B33Y 40/00; B33Y 50/02; B22F 10/28; B22F 10/85; B22F 12/70; B23K 26/342

(52) U.S. Cl. CPC B22F 12/57; B33Y 10/00; B33Y 30/00; B33Y 40/00; B23K 26/123; B22F 10/28; B22F 10/85; B22F 12/70; B23K 26/342; B33Y 50/02

(57) ABSTRACT

A 3D printing system includes a print engine, a powder dispenser, and a controller. The print engine includes a chassis defining an inner chamber with a docking chamber, a build box with a build plate, an energy beam system, and a powder track coater (PTC) coupled to a gantry. The controller is configured to: (A) operate the gantry and the PTC to selectively dispense a track of powder over the build plate, (B) operate the gantry to transport the PTC to the docking station, (C) operate the energy beam system to selectively fuse the track of powder, and (D) concurrent with operating the energy beam to (D1) measure a level of powder in the PTC and (D2) if the level of powder in the PTC is below a predetermined threshold, operate the powder dispenser to transfer a controlled volume of powder to the PTC.

### CROSS-REFERENCE TO RELATED APPLICATIONS

This non-provisional patent application claims priority to U.S. Provisional Application Ser. No. 63/087,105, Entitled “Pulse Transfer for Large Area Metal Fusion System” by Byron Hazlewood et al., filed on Oct. 2, 2020, incorporated herein by reference under the benefit of U.S.C. 119(e).

### STATEMENT OF GOVERNMENT GRANT

This invention was made with government support under Agreement No. W911NF-18-9-000.3 awarded by the U.S. Army Research Laboratory and AMMP Consortium Member Agreement Number 201935 awarded by the National Center for Manufacturing Sciences (NCMS). The government has certain rights in the invention.

### FIELD OF THE INVENTION

The present disclosure concerns an apparatus and method for a layer-by-layer fabrication of three dimensional (3D) articles by selectively fusing metal powder materials. More particularly, the present disclosure concerns a powder supply system suitable for manufacturing very large 3D articles while maintaining quality of a gaseous fabrication environment.

### BACKGROUND

Three dimensional (3D) printing systems are in rapidly increasing use for purposes such as prototyping and manufacturing. One type of three dimensional printer utilizes a layer-by-layer process to form a three dimensional article of manufacture from powdered metallic materials. Each layer of powdered material is selectively coated over a build plane and then selectively fused using an energy beam such as a laser, electron, or particle beam.

There is a desire to rapidly fabricate very large and defect-free 3D articles. One general challenge with such a system is maintenance of a supply of metal and perhaps other powders during a fabrication process while maintaining atmospheric integrity in the printer.

### BRIEF DESCRIPTION OF THE FIGURES

FIG. 1 is a schematic diagram of an additive manufacturing (AM) system for manufacturing a three-dimensional (3D) article.

FIG. 2 is a schematic diagram of a 3D print engine. In the illustrated embodiment, the 3D print engine fabricates a 3D article through a layer by layer fusion melting of metal powder layers.

FIG. 3 is a side view of a first powder supply for providing powder to a second powder supply.

FIG. 4 is a side view of a second powder supply for receiving powder from a first powder supply and for dispensing powder into a powder track coater (PTC). In FIG. 4 is a side-by-side arrangement of two such second powder supplies for receiving and dispensing first and second powders. In an illustrative embodiment, one powder is a metal powder and the second powder is a support powder such as zircon.

FIG. 5 is a lateral plan view of an inner chamber defined by a chassis of a 3D print engine.

FIG. 6 is a vertical sectional view passing through a portion of a 3D print engine.

FIG. 7 is a magnified portion of FIG. 6.

FIG. 8 is flowchart of an embodiment of a method for manufacturing a 3D article.

FIG. 9 is a flowchart of an embodiment of a method for supplying powder from a first silo to a second silo to maintain a powder level in the second silo.

FIG. 10 is a flowchart of an embodiment of a method for dispensing powder from a second silo to a powder track coater (PTC) to maintain a powder level in the PTC.

### SUMMARY

In an aspect of the disclosure, a three-dimensional (3D) printing system for manufacturing a 3D article includes a print engine, a powder dispenser, and a controller. The print engine includes a chassis defining an inner chamber, a build box, an energy beam system, a powder track coater (PTC) and a gantry coupled to the PTC. The inner chamber includes a docking chamber. The build box includes a build plate having an upper surface that laterally contains a build plane. The energy beam system has a maximum lateral extent for fabrication that laterally defines the build plane. The powder dispenser is configured to hold stored powder outside of the inner chamber and extends into the docking chamber. The controller is configured to: (A) operate the gantry to transport the PTC out of the docking chamber and over the build plate, (B) concurrent with transporting the PTC over the build plate, operate the PTC to selectively dispense a track of powder over the build plate, (C) operate the gantry to transport the PTC back to the docking station, (D) operate the energy beam system to selectively fuse the track of powder while the PTC is docked, and (E) concurrent with operating the energy beam to (E1) measure a level of powder in the PTC and (E2) if the level of powder in the PTC is below a predetermined threshold, operate the powder dispenser to transfer a controlled volume of powder to the PTC.

This system is for fabrication of very large 3D articles from metal in a controlled atmosphere that is predominantly composed of a non-oxidizing gas. Within the inner chamber of the chassis the atmospheric requirement is particularly stringent. In an illustrative embodiment, the atmosphere within the print engine chassis is argon with 50 parts per million (PPM) of oxygen. Other portions of the overall printing system have less stringent requirements. It is preferable to minimize the volume requiring 50 PPM oxygen. Thus, it is preferable to store unused powder outside of the chassis. Transferring controlled volumes of powder from outside the chassis to the PTC minimizes an amount of powder stored in the chassis and minimizes the chassis volume. Effecting the transfer while operating the energy beam eliminates impact on the time required to fabricate a 3D article. Finally, the transfer of a controlled volume can be done without significant introduction of oxygen to the inner chamber.

In one implementation, the powder dispenser extends into the docking chamber from above the docking chamber to allow an efficient gravity-induced transfer from the powder dispenser to the PTC. The powder dispenser includes a silo and a dosing chamber below the silo. The dosing chamber is bounded from above by an upper rotary valve and below by a ball valve. A gas handling system is coupled to the dosing chamber. The controller is configured to: (1) operate the rotary valve to release the controlled volume of powder from the silo to the dosing chamber where it falls under the force of gravity, (2) operate the gas handling system to reduce a concentration of oxygen in the dosing chamber and to backfill the dosing chamber with a non-oxidizing gas, (3) operate the ball valve to release the controlled volume of powder to fall from the dosing chamber to the PTC. The controller also receives a signal from a sensor that is indicative of a volume of powder in the PTC. The controller initiates transfer of the controlled volume of powder from the powder dispenser to the PTC when the signal is indicating that a powder level in the PTC is below a certain predetermined threshold. The controlled volume of powder can be less than 0.5 liter, less than 0.3 liter, or about 0.1 liter.

Utilizing the dosing chamber to transfer less than 0.5 liter of powder minimizes an impact of the powder transfer on an environment of the inner chamber (which will tend to introduce some oxygen to the inner chamber). Operating the gas handling system to the concentration of oxygen (evacuating the chamber) further reduces the impact of the powder transfer by reducing oxygen carried by the powder. Backfilling the dosing chamber with the non-oxidizing gas equalizes pressure between the dosing chamber and the inner chamber which facilitates the transfer of powder from the dosing chamber to the PTC.

In another implementation, the inner chamber of the chassis of the print engine can have a more stringent atmosphere including argon and an oxygen content of less than 50 molar parts per million (PPM). A gas handling system achieves this stringent atmosphere by first applying a vacuum to the inner chamber to reduce an oxygen pressure and then “backfilling” the inner chamber with argon. Other portions of the 3D printing system that store powder have a less stringent atmosphere which can include argon with a 2-4 molar percent oxygen content. The less stringent atmosphere may not require applying a vacuum but can be achieved by purging an environment with a non-oxidizing gas such as argon or nitrogen.

### DETAILED DESCRIPTION OF THE PREFERRED EMBODIMENTS

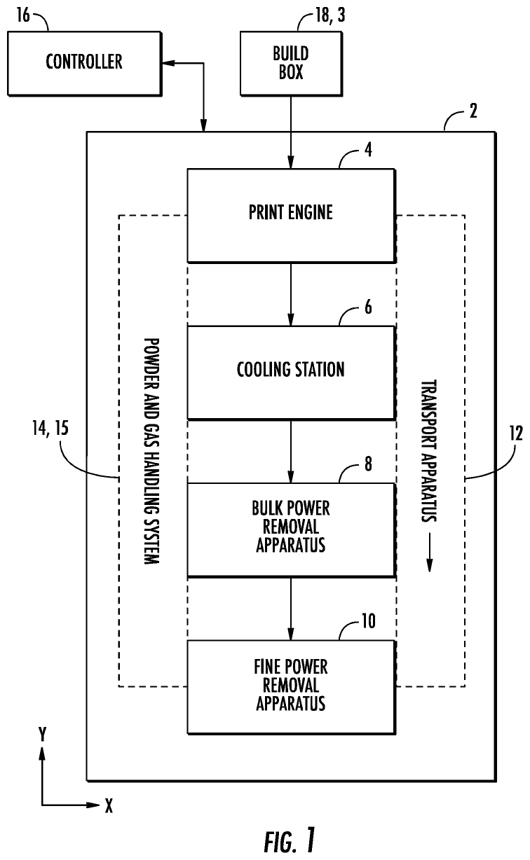

FIG. 1 is a schematic block diagram of an embodiment of an additive manufacturing (AM) system 2 for producing a three-dimensional (3D) article 3. AM system 2 includes a print engine 4, a cooling station 6, a bulk powder removal apparatus 8, a fine powder removal apparatus 10, a transport apparatus 12, a gas handling system 14, powder handling system 15, and a controller 16. The various components 4-15 can individually have separate “lower level” controllers for controlling their internal functions. In some embodiments, a controller 16 can function as a central controller. In the following description, controller 16 will be considered to collectively include all controllers that may reside externally or within the components 4-15. Controller 16 can be internal to AM system 2, external to AM system 2, or include portions that are both internal and external to AM system 2.

The transport apparatus 12 is for transporting a build box 18 through the various components 4-10 in a sequence that includes fabricating, cooling, and de-powdering a 3D article 3 being manufactured. In an illustrative embodiment, the transport apparatus 12 is a rail based system for transporting build box 18, which can weigh several tons when it is loaded with metal powder.

The gas handling system 14 is for controlling an environment for components 4-10. More particularly, the environment is a non-oxidizing environment that includes a non-oxidizing gas such as argon or nitrogen. In an illustrative embodiment, the gas handling system 14 includes a plurality of different gas handing systems 14. The plurality of gas handling systems 14 can differ from each other according to stringency or an oxygen concentration.

The most stringent gas handling system 14 controls an atmosphere internal to the print engine 4. The print engine 4 includes a chassis defining an inner chamber. In an illustrative embodiment, the atmosphere in the inner chamber of print engine 4 has an oxygen content of less than about 100 molar parts per million (PPM) or about 50 PPM. The gas handling system 14 obtains this degree of stringency by first evacuating the inner chamber and then backfilling the inner chamber with argon.

Outside of the inner chamber of the print engine 4, the powder can be maintained in an atmosphere that has an oxygen content within arrange of two to four molar percent oxygen (20,000-40,000 PPM). This is much less stringent. This atmosphere is obtained by purging the powder containers with a non-oxidizing gas but does not require evacuation prior to purging.

The powder handing system 15 has a primary function of storing and providing one or more powders to the print engine 4. The powder handling system 15 also can provide recycling functions and has some degree of integration with the gas handling system. The powder handling system 15 can be integrated or can include more than one independent powder handling system 15. In an illustrative embodiment, the powder handling system 15 includes a powder handling system 50 for supplying two powders to the print engine 4 including a metal powder and a support zircon powder.

The gas handling system 14 includes subsystems for controlling an atmosphere within the powder handling system 50. In one portion of the powder handling system 50 is a powder container such as a silo. The powder container has an upper vented portion. Argon can be introduced at a lower portion of the powder container. Because argon is more dense than air, the argon will fill the container as the air rises out of the container. This is sufficient to maintain a less stringent atmosphere in the container of perhaps 2-4 molar percent oxygen. The gas handling system can also include a subsystem that evacuates and backfills a small portion of the powder handling system 50 just before the powder is transferred from the powder handling system 50 into the print engine 4.

Controller 16 includes a processor coupled to a non-transient or non-volatile information storage device which stores software instructions. When executed by the processor, the software instructions operate any or all portions of the system 2. In an illustrative embodiment, gas handling, powder handling, fabrication, cooling, de-powdering, and other functions can be performed in a fully automated way by controller 16. In some embodiments, certain steps of manufacturing can also be handled manually.

Controller 16 is configured to perform steps such as (1) operate gas handling system 14 to evacuate and/or backfill components 4-10, (2) operate print engine 4 to fabricate a 3D article in build box 18, (3) operate transport apparatus 12 to transport build box 18 (which now contains the 3D article and unfused powder) to the cooling station 6, (4) after an appropriate cooling time, operate transport apparatus 12 to transport build box 18 to bulk powder removal apparatus 8, (5) operate bulk powder removal apparatus 8 to remove most of the unfused powder from the build box 18, and (6) operate transport apparatus 12 to transport the build box 18 to the fine powder removal apparatus 10. At the fine powder removal apparatus 10, residual unfused powder is removed either automatically or manually. All the while, controller 16 operates the gas handling system 14 to maintain a non-oxidizing gaseous environment within the components 4-10 as required. In an illustrative embodiment, the controller 16 also operates the powder handling system 15 to provide powder to the print engine 4 during fabrication of the 3D article.

AM system 2 can have other components such as an inspection station or a station for facilitating unloading of the 3D article 100 from the build box 18. The additional components can be manually operated or within the control of controller 16.

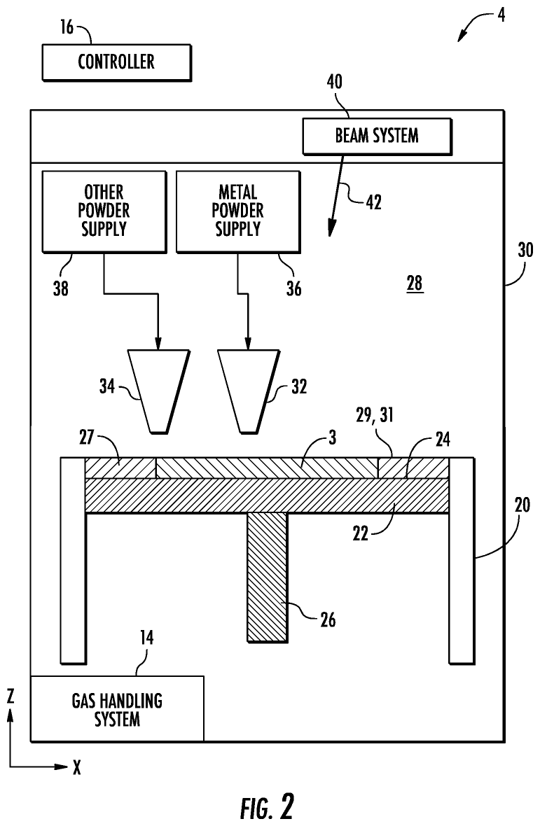

FIG. 2 is a schematic diagram of an embodiment of a 3D print engine 4 for fabricating a 3D article 3. In describing FIG. 2 and for subsequent figures, mutually orthogonal axes X, Y and Z can be used. Axes X and Y are lateral axes that are generally horizontal. Axis Z is a vertical axis that is generally aligned with a gravitational reference. By “generally” it is intended to be so by design but may vary due to manufacturing or other tolerances.

The build box 18 (FIG. 1) includes a powder bin 20 containing a build plate 22. Build plate 22 has an upper surface 24 and is mechanically coupled to a vertical positioning system 26. The build box 18 is configured to contain selectively coated metal powder 27. The build box 18 is contained within inner chamber 28 surrounded by housing or chassis 30.

The vertical positioning system 26 is configured to position the upper surface 24 under control of controller 16. In an illustrative embodiment, the vertical positioning system 26 includes a lead screw coupled to a vertically fixed nut. The nut is coupled to a motor. As the nut is rotated by the motor, inside threads of the nut engage outer threads of the lead screw, causing a tip of the lead screw to either lift or lower the build plate 22. Of course, this is but one example of a vertical positioning system. In another example, the lead screw can be fixed vertically and a nut can rise and fall under a motorized turning of the lead screw. The nut can be coupled to a lever or follower that is in turn mechanically coupled to the build plate 22. The motorized rotation of the lead screw would then cause the lever or follower to raise and lower the build plate 22. Other examples are possible for vertical positioning system 26.

A metal powder track coater (PTC) 32 is configured to dispense tracks or layers of metal powder 27 upon the upper surface 24 of the build plate 22 or on previously dispensed layers of metal powder 27. When a layer of powder 27 is just dispensed, it has an upper surface 29 that is preferably coincident or coplanar with a build plane 31. In some operational implementations, the upper surface 29 may be positioned slightly below build plane 31.

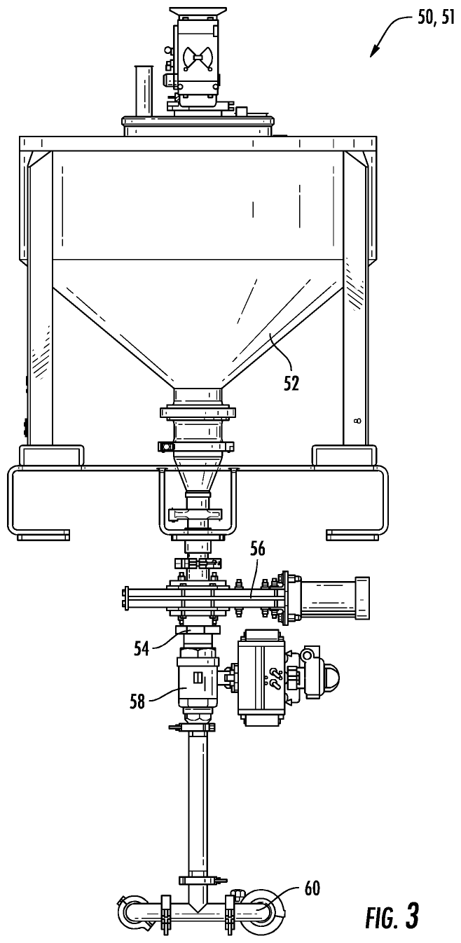

In the illustrated embodiment, a second powder track coater (PTC) 34 is configured to dispense an additional powder. Powder track coaters 32 and 34 are configured to receive powder from powder supplies 36 and 38 respectively. The additional powder may be a different metal powder, the same metal powder, or a support material such as zircon. The print engine 4 can include more than two powder track coaters to allow multiple different materials to be dispensed. Some of the description concerning FIGS. 3-10 concern or refer to a powder supply 50. It is to be understood that the description for powder supply 50 can pertain to powder supply 36 or 38.

Print engine 4 includes a beam system 40 configured to generate an energy beam 42 for selectively fusing layers of dispensed metal powder. In an illustrative embodiment, the beam system 40 includes a plurality of high power lasers for generating radiation beams individually having an optical power of at least 100 watts, at least 500 watts, about 1000 watts, at least 1000 watts, or another optical powder level. The beam system 40 can include optics for individually steering the radiation beams across the build plane 31 that is generally coincident with the upper surface 29 of the metal powder 27 layer. In alternative embodiments, the beam system 40 can generate electron beams, particle beams, or a hybrid mixture of different beam types.

The build plane 31 is defined laterally by a maximum lateral area that is addressable by the beam system 40 and is defined vertically by a focus of the beam system 40. The maximum lateral area may be limited by software and/or hardware limits. The lateral area of the build plane 31 is within the lateral area of the build plate 22. Preferably there is a laterally defined boundary region between the build plate 31 and the powder bin 20 to facilitate removal of unfused powder 27.

In an illustrative embodiment, the build plane 31 has a lateral area that is at least about 0.5 square meters or at least about 0.7 square meters. Larger areas are possible. In the illustrated disclosure, the build plane 31 has an area of about one square meter and the print engine 4 can process up to four tons or more of metal during a build process. This is a uniquely large area for selectively dispensing and fusing metal powders.

FIGS. 3-10 describe an apparatus and operation of a powder supply 50. Powder supply 50 can provide powder for either of powder track coaters 32 and 34. The description of FIGS. 3-10 will begin with the apparatus in FIGS. 3-7 and then with operation in FIGS. 8-10.

FIG. 3 is a side view of a first powder supply 51 of powder supply 50 which resides outside of the inner chamber 28. A first silo 52 stores a first amount of powder. In an illustrative embodiment, first silo 52 stores more than 100 liters of powder or about 120 liters of powder. Below first silo 52 is a first dosing section 54 that is between a first upper valve 56 and a first lower valve 58. In an illustrative embodiment the first upper valve 56 is an orifice gate valve 56 and the first lower valve 58 is a first ball valve 58. Below first lower valve 58 is a transport conduit 60. A steady stream of non-oxidizing transport gas maintained in the transport conduit 60. Operation of the intermediate supply 51 in FIG. 3 will be described with respect to FIG. 8.

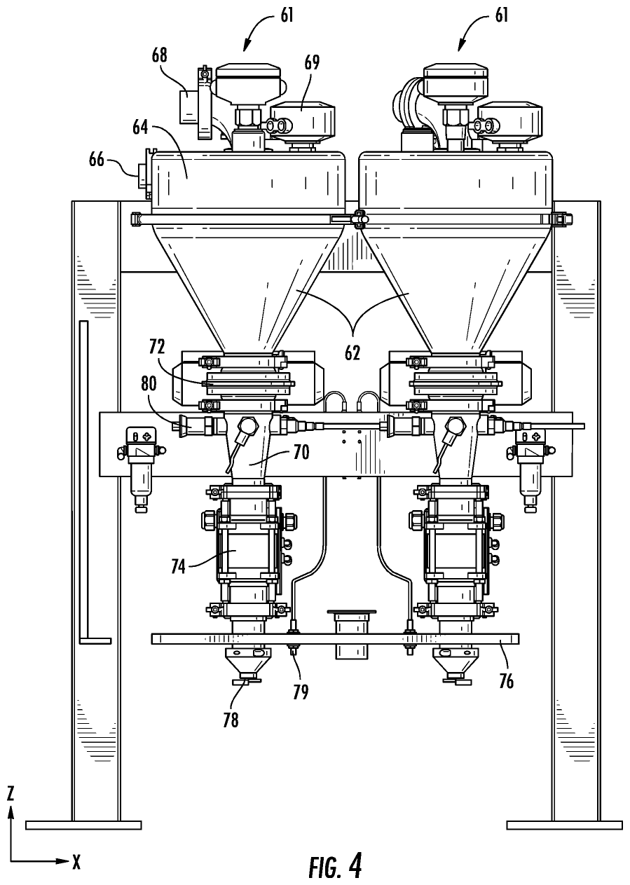

FIG. 4 is a side view of a side by side arrangement of two second powder supplies 61 of powder supply 50. Second powder supply 61 can also be referred to as a powder dispenser 61. Powder supply 50 includes the first supply 51 and the second supply 61. The first powder supply 51 is configured to provide powder to the powder dispenser 61. A second silo 62 stores a second amount of powder. Above the second silo 62 is a cyclone 64 having an inlet 66 and outlet 68. The inlet 66 is coupled to the transport conduit 60 for receiving gas with entrained powder. The powder is separated from the gaseous stream by cyclone 64 and falls down into the second silo 62. The second silo 62 can include a sensor 69 for providing information indicative of a level of powder in the second silo 62. In an illustrative embodiment, sensor 69 can include a low level sensor and a high level sensor.

Below second silo 62 is a second dosing chamber 70 that is between a second upper valve 72 and a second lower valve 74. In an illustrative embodiment, the second upper valve 72 is a rotary valve 72 and the second lower valve 74 is a second ball valve 74. The second dosing chamber 70 can have a capacity in a range of 0.1 liter to 0.5 liter or about 0.3 liter. In the illustrative embodiment, the second lower valve 74 is above a chamber wall 76 that partially encloses the inner chamber 28. Below the chamber wall 76 is an outlet or docking connection 78 of the powder dispenser 61. Also shown is a sensor 79 configured to sense a powder level in the PTC 32 (or 34).

Coupled to the second dosing chamber 70 is a gas handling system 80. Gas handling system 80 includes at least one sensor for sensing an oxygen concentration and a total gauge pressure in the second dosing chamber 70.

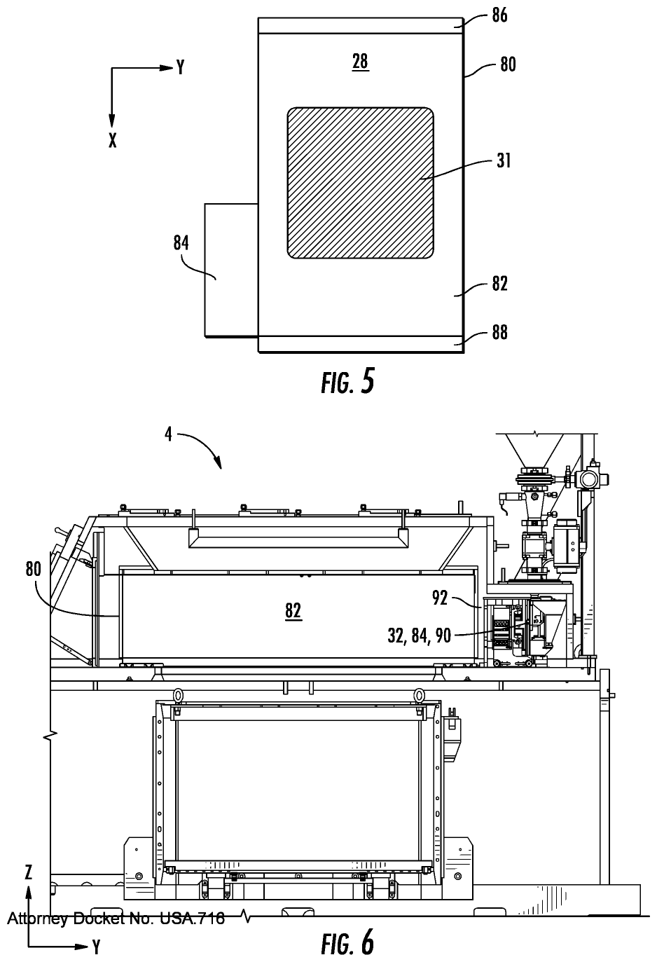

FIG. 5 is a lateral plan view of the inner chamber 28. Inner chamber 28 is bounded by a plurality of lateral walls 80 and includes a process chamber 82 and a docking chamber 84. The process chamber 82 laterally contains the build plane 31. During a fabrication process, gas generally flows across the process chamber 82 from a gas inlet 86 to a gas outlet 88. Uniformity of gas flow, particularly across build plane 31, is important.

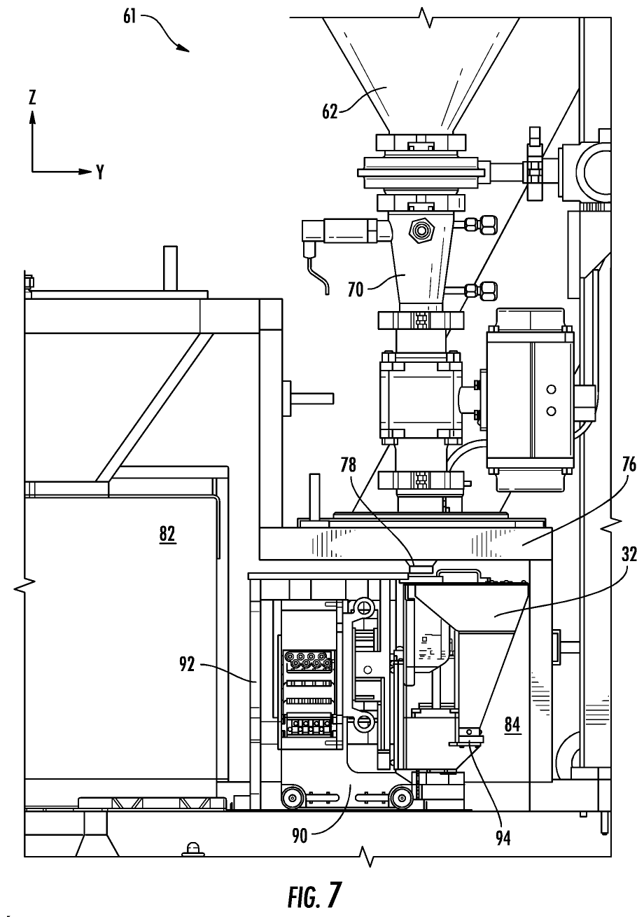

FIG. 6 is a vertical sectional view passing through a portion of the print engine 4. The PTC 32 is shown docked in the docking chamber 84. The PTC 32 is mechanically coupled to a gantry 90. The gantry 90 includes and supports a wall 92. The wall 92 separates the docking chamber 84 from the process chamber 82 when the PTC 32 is in a docked position in the docking chamber 84. This separation provides a process chamber 82 having a simple rectangular cross-section in Y and Z which eliminates vortex gas currents that would be formed in the absence of the wall 92 and provides a more uniform flow velocity between the gas inlet 86 and gas outlet 88.

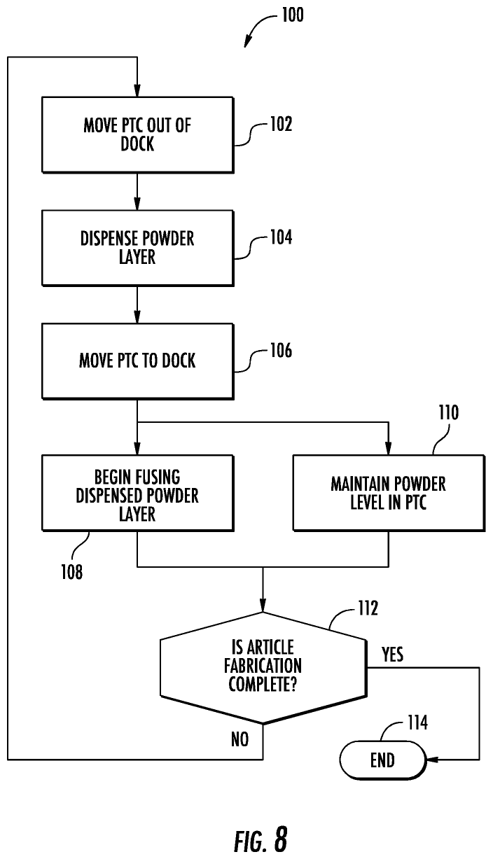

FIG. 7 is a magnified portion of FIG. 6 with the PTC 32 in a docked position for receiving powder from powder dispenser 61. The PTC 32 has an outlet 94 for selectively dispensing tracks of powder 27 over the build plate 22. While the views of FIGS. 6 and 7 illustrate a single PTC 32—in an illustrative embodiment, powder dispensers 32 (metal powder) and 34 (support material or second metal powder) are both docked below two powder dispensers 61.

FIG. 8 is a flowchart of an embodiment of a method for manufacturing a 3D article performed in an automated way by controller 16. According to 102, the gantry 90 is operated to move the PTC 32 out of the docking chamber 84 and to the lateral area of build plane 31. According to 104, the gantry 90 and the PTC 32 are operated to selectively dispense a track or layer of powder. This includes (1) operating the gantry 90 to transport the outlet 94 of PTC 32 over an upper surface 29 and following some pattern and (2) concurrent with operating the gantry operating the PTC 32 to selectively deposit a track or layer of powder upon the surface 29.

According to 106, the gantry 90 transports and docks the PTC 32 in the docking chamber 84. As a result of step 106, the wall 92 is positioned to divide off the docking chamber 84 from the process chamber 82. At this point, two parallel processes can take place including 108 and 110.

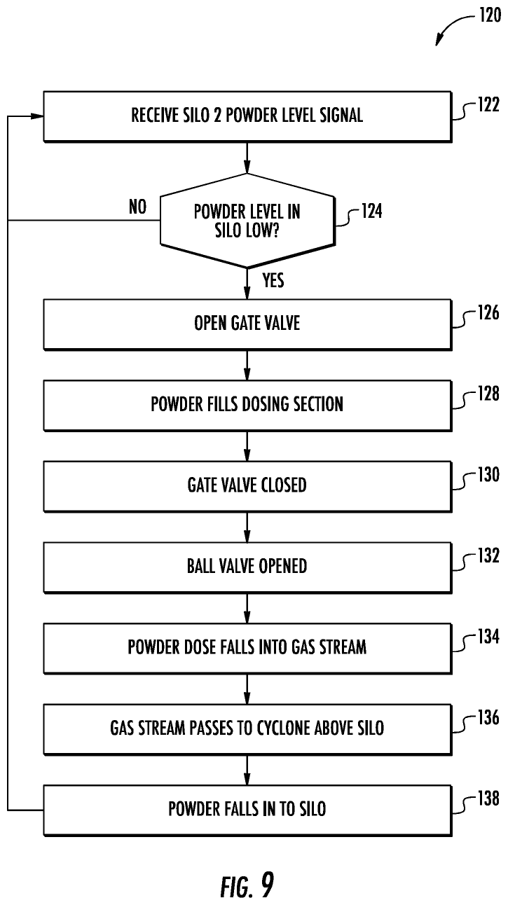

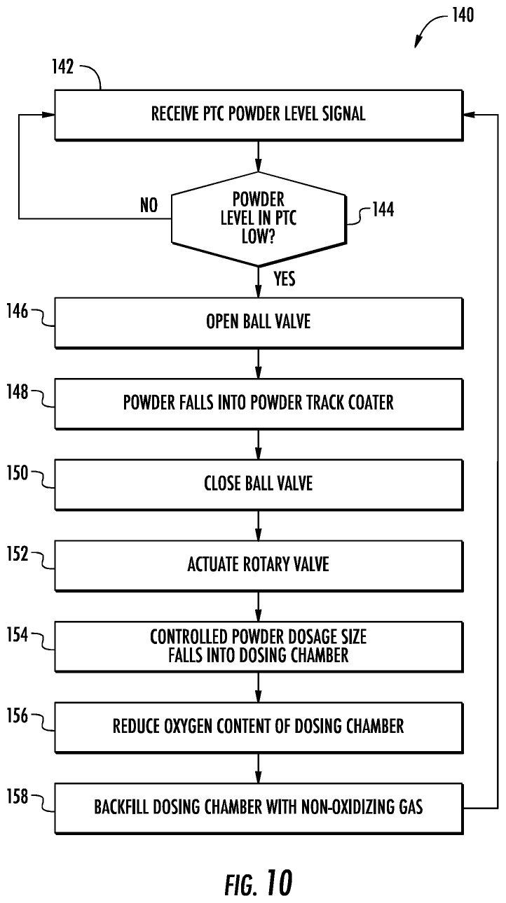

According to 108, the powder track or layer dispensed in step 104 is selectively fused. This is accomplished by (1) operating the gas handling system 14 to establish a flow of gas from the gas inlet 86 to the gas outlet 88 and (2) operating the beam system 40 to selectively fuse the layer or track of dispensed powder. According to 110—concurrent with 108, the powder handling system 50 is operated to maintain a controlled level of powder in the PTC 32. While 110 is illustrated as a step in method 100, it encompasses methods 120 and 140 to be discussed with respect to FIGS. 9 and 10 infra.

According to 112, a determination is made as to whether all layers of article 3 have been fused. If so, then the method 100 ends according to 114. If not, then the process loops back to step 102.

FIGS. 9 and 10 are flowcharts depicting details pertaining to step 110 of FIG. 8. FIG. 9 concerns a method 120 of maintaining a powder level in the second powder silo 62. According to 122, a signal is received and analyzed from sensor(s) 69 to determine a powder level in the second silo 62. According to 124, a determination is made as to whether the powder level is low. If not, then the process loops back to 122 and the sensor(s) continue(s) to be monitored. If the powder level is low, then the process proceeds to step 126.

According to 126 gate valve 56 is opened. According to 128, powder from first powder silo 52 falls under a force of gravity into the first dosing section 54. According to 130, the gate valve 56 is closed after a controlled dose of powder has been received in the dosing section 54. In an illustrative embodiment, the amount of powder received in dosing section 54 is within a volume range of 0.3 to 0.7 liter or about 0.5 liter.

According to 132, the first lower valve 58 is opened. According to 134, the controlled dose of powder in dosing section 54 then falls into the transport conduit 60. Concurrent with the dose of powder falling, the transport conduit 60 is transporting gas with a velocity sufficient to entrain the dose of powder.

According to 136, the gas stream with entrained powder in transport conduit 60 passes into the cyclone 64. According to 138, the controlled dose of powder falls into the second silo 62. The process then loops back to 122. As a note, controller 16 receives the sensor data and then operates valves 56 and 58 according to steps 122, 124, 126, 130, and 132. Other steps of method 120 are consequences of the controller operation. Controller 16 can also modulate gas flow through the transport conduit 60 as needed.

FIG. 10 concerns a method 140 of maintaining a powder level in the PTC 32. Refer to FIGS. 4 and 7 in reference to method 140. According to 142, a signal is received from sensor 79 that is indicative of a powder level in the PTC 32. According to 144, a determination is made as to whether a powder level in the PTC 32 is low. It not, the method loops back to step 142. Otherwise, the method proceeds to step 146.

According 146, the second lower valve 74 is opened. According to 148, a controlled volume or dose of powder contained in the second dosing chamber 70 falls under a force of gravity into the PTC 32. According to 150, the second lower valve is closed. Because the second dosing chamber is now empty, it is refilled according to steps 152-158.

According to 152 and 154, rotary valve 72 is actuated to release a controlled dose of powder from the second powder silo 62 into the second dosing chamber 70. According to 156, the gas handling system 80 is operated to evacuate gas including oxygen from the second dosing chamber 70. According to 158, the gas handling system is operates to backfill the second dosing chamber 70 with a non-oxidizing gas. After step 158, the method 140 loops back to step 142. As a note, the controller 16 receives information from sensor 79, actuates valves 74 and 72, and operates the gas handling system 80 according to steps 142-146, 150, 152, 156, and 158. Steps 148 and 154 are actions that result from the controller actions to illustrate the method.

The specific embodiments and applications thereof described above are for illustrative purposes only and do not preclude modifications and variations encompassed by the scope of the following claims.

What is claimed:

1. A three-dimensional (3D) printing system comprising:
a print engine including:
a chassis defining an inner chamber including a docking chamber;
a build box including a build plate having an upper surface that laterally contains a build plane;
an energy beam system having a maximum lateral extent for fabrication that laterally defines the build plane;
a powder track coater (PTC); and
a gantry coupled to the PTC; and
a powder dispenser configured to hold stored powder outside of the inner chamber and extending into the docking chamber;
a controller configured to:
operate the gantry to transport the PTC out of the docking chamber and over the upper surface of the build plate;
concurrent with transporting the PTC over the upper surface of the build plate, operate the PTC to selectively dispense a track of powder over the build plate;
operate the gantry to transport the PTC back to the docking station;
operate the energy beam system to selectively fuse the track of powder; and
concurrent with operating the energy beam:
measure a level of powder in the PTC; and
if the level of powder in the PTC is below a predetermined threshold, operate the powder dispenser to transfer a controlled volume of powder to the PTC.

2. The three-dimensional (3D) printing system of claim 1 wherein the powder dispenser includes a silo that is positioned physically above the docking chamber, the silo holds the stored powder.

3. The three-dimensional (3D) printing system of claim 2 wherein the powder dispenser includes a lower valve below the silo and defines a dosing chamber between the silo and the lower valve, the operating the powder dispenser to transfer the controlled volume of powder to the PTC includes opening the lower valve to allow the controlled volume of powder to fall from the dosing chamber and into the PTC.

4. The three-dimensional (3D) printing system of claim 3, wherein the lower valve is a ball valve.

5. The three-dimensional (3D) printing system of claim 3 wherein the powder dispenser includes an upper valve between the silo and the dosing chamber, the controller is configured to replace the controlled volume of powder by operating the upper valve.

6. The three-dimensional (3D) printing system of claim 5 wherein the upper valve is a rotary valve.

7. The three-dimensional (3D) printing system of claim 5 further comprising a gas handling system coupled to the dosing chamber, the controller is configured to evacuate oxygen from the dosing chamber and to backfill the intermediate chamber with an non-oxidizing gas before opening the lower valve so as to minimally introduce oxygen to the inner chamber.

8. The three-dimensional (3D) printing system of claim 1 wherein the controlled volume of powder has a volume of less than 0.5 liter.

9. The three-dimensional (3D) printing system of claim 1 wherein the controlled volume of powder has a volume of less than 0.3 liter.

10. The three-dimensional (3D) printing system of claim 1 wherein the gantry supports a wall that is configured to isolate the docking chamber from a remaining portion of the inner chamber during operation of the beam system.

11. A method of manufacturing a three-dimensional (3D) article comprising:
providing a three-dimensional (3D) printing system including:
a print engine including:
a chassis defining an inner chamber including a docking chamber;
a build box including a build plate having an upper surface that laterally contains a build plane;
an energy beam system having a maximum lateral extent for fabrication that laterally defines the build plane;
a powder track coater (PTC); and
a gantry coupled to the PTC; and
a powder dispenser configured to hold stored powder outside of the inner chamber and extending into the docking chamber;
operating the gantry to transport the PTC out of the docking chamber and over the upper surface of the build plate;
concurrent with transporting the PTC over the upper surface of the build plate, operating the PTC to selectively dispense a track of powder over the build plate
operating the gantry to transport the PTC back to the docking station;
operating the energy beam system to selectively fuse the track of powder; and
concurrent with operating the energy beam:
measuring a level of powder in the PTC; and
if the level of powder in the PTC is below a predetermined threshold, operating the powder dispenser to transfer a controlled volume of powder to the PTC.

12. The method of claim 11 wherein the powder dispenser includes a silo that is positioned physically above the docking chamber and transferring the controlled volume of powder is done vertically and from outside and into a controlled gaseous environment of the docking chamber.

13. The method of claim 12 wherein the powder dispenser includes a lower valve below the silo and defines an intermediate chamber between the silo and the lower valve, the operating the powder dispenser to transfer the controlled volume of powder to the PTC includes opening the lower valve to allow the controlled volume of powder to fall from the intermediate chamber and into the PTC.

14. The method of claim 13, wherein the lower valve is a ball valve and opening the lower valve includes opening the ball valve.

15. The method of claim 13, wherein the powder dispenser includes an upper valve between the silo and the intermediate chamber, and further comprising replacing the controlled volume of powder by operating the upper valve.

16. The method of claim 15 wherein the upper valve is a rotary valve, operating the upper valve includes operating the rotary valve.

17. The method of claim 15 further comprising a gas handling system coupled to the intermediate chamber and further comprising operating the gas handling system to evacuate oxygen from the intermediate chamber and to backfill the intermediate chamber with an non-oxidizing gas before opening the lower valve so as to minimally introduce oxygen to the inner chamber.

18. The method of claim 11 wherein the controlled volume of powder has a volume of less than 0.5 liter.

19. The method of claim 11 wherein the controlled volume of powder has a volume of less than 0.3 liter.

20. The method of claim 11 wherein the gantry supports a wall portion and further comprising isolating the docking chamber from a remaining portion of the inner chamber during operation of the beam system through the positioning of the wall portion during docking.
